(19) United States
(12) Patent Application Publication
(10) Pub. No.: US 2013/0271444 A1
(43) Pub. Date: Oct. 17, 2013

(54) Liquid Crystal Display Device and Display Panel Thereof

(71) Applicants: Jinjie Wang, Shenzhen (CN); Cheng-hung Chen, Shenzhen (CN)

(72) Inventors: Jinjie Wang, Shenzhen (CN); Cheng-hung Chen, Shenzhen (CN)

(73) Assignee: SHENZHEN CHINA STAR OPTOELECTRONICS TECHNOLOGY CO., LTD., Bao'an District, Shenzhen, Guangdong (CN)

(21) Appl. No.: 13/519,317

(22) PCT Filed: Apr. 16, 2012
(86) PCT No.: PCT/CN12/74084

§ 371 Date: Jun. 26, 2012

(30) Foreign Application Priority Data
Apr. 11, 2012 (CN) 201210104868.7

(51) Int. Cl. G09G 3/36; G06F 3/038

(52) U.S. Cl. 345/212; 345/92

(57) ABSTRACT

The present invention provides a liquid crystal display device and display panel thereof. The display panel includes data lines, scan lines disposed intersecting the data lines, pixel electrodes within area formed by two adjacent scan lines and two adjacent data lines, and thin film transistors disposed at intersecting points of scan lines and data lines; gate terminal of thin film transistor connected to scan line, source terminal of thin film transistor connected to data line and drain terminal of thin film transistor connected to pixel electrode. Overlapping area of drain terminal of thin film transistor and scan line forms parasitic capacitor C_{gs}, and overlapping area of drain terminal of thin film transistor and scan line increases from signal input end to signal out end of a same scan line so that capacitance of parasitic capacitor increases along the same line.

### BACKGROUND OF THE INVENTION

1. Field of the Invention

The present invention relates to the field of liquid crystal displaying techniques, and in particular to a liquid crystal display device and display panel thereof.

2. The Related Arts

The drive circuit for known liquid crystal displaying techniques includes scan lines 110, data lines 120, thin film transistors 130, liquid crystal capacitors 141 and storage capacitors 142; wherein liquid crystal capacitor 141 is formed by pixel electrode 1411 disposed on first substrate and common electrode 1413 disposed on second substrate. Storage capacitor 142 is formed by pixel electrode 1411 and common electrode 1423 disposed on first substrate. Gate terminal g of thin film transistor 130 is connected to scan line 110, source terminal s is connected to data line 120 and drain terminal d is connected to pixel electrode 1411.

When operating, scan signal is loaded through scan line 110 to gate terminal g of thin film transistor 130 to make thin film transistor 130 conductive; data signal is loaded to source terminal s of thin film transistor 130. When scan signal makes thin film transistor 130 in conductive state, data signal is loaded through drain terminal d of thin film transistor 130 to pixel electrode 1411 of liquid crystal capacitor 141. When voltage applied to liquid crystal capacitor 141 changes, polarization direction of liquid crystal molecules in liquid crystal layer also changes, and results in controlling the light transmittance of light passing through pixel unit and display illumination of each pixel unit.

FIG. 2 shows a waveform diagram of scan signal of circuit and voltage on pixel electrode as shown in FIG. 1. Refer to also FIG. 2. Because of parasitic capacitor 150, the moment thin film transistor 130 shuts down (i.e., scan signal 210 in negative edge), parasitic capacitor 150 pulls scan signal 210 to pixel electrode 1411 to reduce voltage 220 loaded to pixel electrode 1411. The reduced voltage is called feed-through voltage.

Because capacitance of parasitic capacitor 150 on the same scan line 110 increases from signal input end to signal output end, feed-through voltage pulled in by parasitic capacitor 150 gradually decreases so that voltage difference between pixel electrode 1411 and common electrode 1413 disposed on second substrate gradually increases and leads to different feed-through voltage at different location; in other words, feed-through voltage is higher at signal input end, and lower at signal output end. The result is that for low grayscale image, the defect of non-uniform illumination occurs to affect the quality of displaying.

### SUMMARY OF THE INVENTION

The technical issue to be addressed by the present invention is to provide a liquid crystal display device and display panel thereof, which effectively reduces impact of feed-through voltage on pixel units at signal input end and signal output end of the same scan line.

The present invention provides a liquid crystal display panel, which comprises: data lines, scan lines disposed intersecting the data lines, pixel electrodes within area formed by two adjacent scan lines and two adjacent data lines, and thin film transistors disposed at intersecting points of scan lines and data lines; gate terminal of thin film transistor connected to scan line, source terminal of thin film transistor connected to data line and drain terminal of thin film transistor connected to pixel electrode; wherein overlapping area of drain terminal of thin film transistor and scan line forming parasitic capacitor C_{gs}, and the overlapping area of drain terminal of thin film transistor and scan line increasing from signal input end to signal out end of a same scan line so that capacitance of parasitic capacitor C_{gs} increasing along the same line; wherein capacitance of parasitic capacitor C_{gs} satisfying following equation:

$$Δ V = Δ {V}_{g} * \frac{{C}_{gs}}{{C}_{gs} + {C}_{sl} + {C}_{lc}}$$

According to a preferred embodiment of the present invention, ΔV is compensation voltage, ΔV_{g} is difference between high voltage and low voltage of scan signal inputted to gate terminal of thin film transistor of a pixel unit, Cₛₜ is capacitance of storage capacitor of pixel unit, and C_{lc} is capacitance of liquid crystal capacitor of pixel unit.

According to a preferred embodiment of the present invention, scan line comprises convex part at location corresponding to adjacent thin film transistor, the drain terminal of thin film transistor comprises extension part, overlapping part of the convex part and extension part forms parasitic capacitor C_{gs}, wherein area of convex part on scan line at location close to signal input end is less than area of convex part on scan line at location close to signal output end.

According to a preferred embodiment of the present invention, area of convex part increases from signal input end to signal output end of same scan line, and area of extension part remains the same.

The present invention provides a liquid crystal display panel, which comprises: data lines, scan lines disposed intersecting the data lines, pixel electrodes within area formed by two adjacent scan lines and two adjacent data lines, and thin film transistors disposed at intersecting points of scan lines and data lines; gate terminal of thin film transistor connected to scan line, source terminal of thin film transistor connected to data line and drain terminal of thin film transistor connected to pixel electrode; wherein overlapping area of drain terminal of thin film transistor and scan line forming parasitic capacitor C_{gs}, and the overlapping area of drain terminal of thin film transistor and scan line increasing from signal input end to signal out end of a same scan line so that capacitance of parasitic capacitor C_{gs} increasing along the same line.

According to a preferred embodiment of the present invention, wherein capacitance of parasitic capacitor C_{gs} satisfying following equation:

$$Δ V = Δ {V}_{g} * \frac{{C}_{gs}}{{C}_{gs} + {C}_{sl} + {C}_{lc}}$$

According to a preferred embodiment of the present invention, ΔV is compensation voltage, ΔV_{g} is difference between high voltage and low voltage of scan signal inputted to gate terminal of thin film transistor of a pixel unit, Cₛₜ is capacitance of storage capacitor of pixel unit, and C_{lc} is capacitance of liquid crystal capacitor of pixel unit.

According to a preferred embodiment of the present invention, area of overlapping part between drain terminal of thin film transistor and scan line increases from signal input end to signal output end of same scan line.

According to a preferred embodiment of the present invention, scan line comprises convex part at location corresponding to adjacent thin film transistor, the drain terminal of thin film transistor comprises extension part; overlapping part of the convex part and extension part forms parasitic capacitor C_{gs}, wherein area of convex part on scan line at location close to signal input end is less than area of convex part on scan line at location close to signal output end.

According to a preferred embodiment of the present invention, area of convex part increases from signal input end to signal output end of same scan line, and area of extension part remains the same.

According to a preferred embodiment of the present invention, scan line comprises convex part at location corresponding to adjacent thin film transistor, the drain terminal of thin film transistor comprises extension part, overlapping part of the convex part and extension part forms parasitic capacitor C_{gs}, wherein area of extension part on scan line at location close to signal input end is less than area of extension part on scan line at location close to signal output end.

According to a preferred embodiment of the present invention, area of extension part increases from signal input end to signal output end of same scan line, and area of convex part remains the same.

According to a preferred embodiment of the present invention, the drain terminal of thin film transistor comprises extension part, overlapping part of the scan line and extension part forms parasitic capacitor C_{gs}, wherein area of extension part increases from signal input end to signal output end of same scan line.

According to a preferred embodiment of the present invention, distance of overlapping part between drain terminal of thin film transistor and scan line decreases from signal input end to signal output end of same scan line.

The present invention provides a liquid crystal display device, which comprises: a liquid crystal display panel and a backlight module; wherein the liquid crystal display panel comprises: data lines, scan lines disposed intersecting the data lines, pixel electrodes within area formed by two adjacent scan lines and two adjacent data lines, and thin film transistors disposed at intersecting points of scan lines and data lines; gate terminal of thin film transistor connected to scan line, source terminal of thin film transistor connected to data line and drain terminal of thin film transistor connected to pixel electrode; overlapping area of drain terminal of thin film transistor and scan line forming parasitic capacitor C_{gs}, and the overlapping area of drain terminal of thin film transistor and scan line increasing from signal input end to signal out end of a same scan line so that capacitance of parasitic capacitor C_{gs} increasing along the same line.

According to a preferred embodiment of the present invention, wherein capacitance of parasitic capacitor C_{gs} satisfying following equation:

$$Δ V = Δ {V}_{g} * \frac{{C}_{gs}}{{C}_{gs} + {C}_{sl} + {C}_{lc}}$$

According to a preferred embodiment of the present invention, ΔV is compensation voltage, ΔV_{g} is difference between high voltage and low voltage of scan signal inputted to gate terminal of thin film transistor of a pixel unit, Cₛₜ is capacitance of storage capacitor of pixel unit, and C_{lc} is capacitance of liquid crystal capacitor of pixel unit.

According to a preferred embodiment of the present invention, area of overlapping part between drain terminal of thin film transistor and scan line increases from signal input end to signal output end of same scan line.

According to a preferred embodiment of the present invention, scan line comprises convex part at location corresponding to adjacent thin film transistor, the drain terminal of thin film transistor comprises extension part, overlapping part of the convex part and extension part forms parasitic capacitor C_{gs}, wherein area of convex part on scan line at location close to signal input end is less than area of convex part on scan line at location close to signal output end.

According to a preferred embodiment of the present invention, area of convex part increases from signal input end to signal output end of same scan line, and area of extension part remains the same.

According to a preferred embodiment of the present invention, scan line comprises convex part at location corresponding to adjacent thin film transistor, the drain terminal of thin film transistor comprises extension part, overlapping part of the convex part and extension part forms parasitic capacitor C_{gs}, wherein area of extension part on scan line at location close to signal input end is less than area of extension part on scan line at location close to signal output end.

According to a preferred embodiment of the present invention, area of extension part increases from signal input end to signal output end of same scan line, and area of convex part remains the same.

According to a preferred embodiment of the present invention, the drain terminal of thin film transistor comprises extension part, overlapping part of the scan line and extension part forms parasitic capacitor C_{gs}, wherein area of extension part increases from, signal input end to signal output end of same scan line.

The efficacy of the present invention is that to be distinguished from the state of the art. The present invention uses parasitic capacitors formed by overlapping drain terminal of thin film transistor and scan line, and capacitance increases from signal input end to signal output end along scan line, so that feed-through voltage at output end approaches the same as feed-through voltage at input end to effectively reduce impact on pixels from signal input end to signal output end along same scan line by feed-through voltage, and improve the illumination uniformity of liquid crystal display device, and improve quality of displaying.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing a drive circuit of a known liquid crystal display device;

FIG. 2 is a waveform diagram of scan signal of circuit shown in FIG. 1 and voltage on pixel electrode;

FIG. 3 is a schematic view showing the structure of a liquid crystal display panel according to the present invention;

FIG. 4 is a schematic view showing the structure of a parasitic capacitor at signal input end of the first embodiment of the liquid crystal display panel according to the present invention;

FIG. 5 is a schematic view showing the structure of a parasitic capacitor at signal output end of the first embodiment of the liquid crystal display panel according to the present invention;

FIG. 6 is a schematic view showing the structure of a parasitic capacitor at signal input end of the second embodiment of the liquid crystal display panel according to the present invention;

FIG. 7 is a schematic view showing the structure of a parasitic capacitor at signal output end of the second embodiment of the liquid crystal display panel according to the present invention;

FIG. 8 is a schematic view showing the structure of the third embodiment of the liquid crystal display panel according to the present invention; and

FIG. 9 is a cross-section view along A-A direction of FIG. 8.

### DETAILED DESCRIPTION OF THE PREFERRED EMBODIMENTS

The following detailed description refers to drawings and embodiment of the present invention.

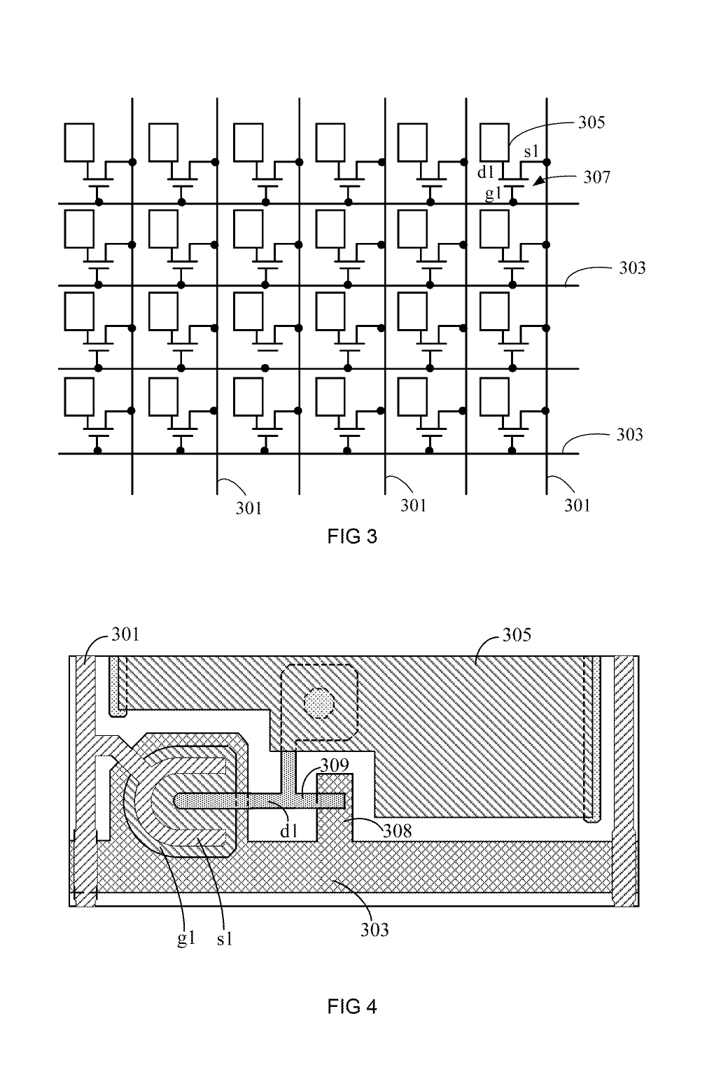

Referring to FIG. 3, FIG. 3 is a schematic view showing the structure of an embodiment of a liquid crystal display panel according to the present invention. The liquid crystal display of the present embodiment comprises: a plurality of data lines 301, a plurality of scan lines 303 disposed intersecting data lines 301, pixel electrodes 305 within area formed by two adjacent scan lines 303 and two adjacent data lines 301, and thin film transistors 307 disposed at intersecting points of scan lines 303 and data lines 301.

In the instant embodiment, gate terminal g1 of thin film transistor 307 is connected to scan line 303, source terminal s1 of thin film transistor 307 is connected to data line 301 and drain terminal d1 of thin film transistor 307 is connected to pixel electrode 305.

Referring to FIGS. 4-5, FIG. 4 is a schematic view showing the structure of a parasitic capacitor at signal input end of the first embodiment of the liquid crystal display panel according to the present invention; and FIG. 5 is a schematic view showing the structure of a parasitic capacitor at signal output end of the first embodiment of the liquid crystal display panel according to the present invention. In the instant embodiment, overlapping area of drain terminal d1 of thin film transistor 307 and scan line 303 forms parasitic capacitor, and the overlapping area of drain terminal of thin film transistor and scan line increasing from signal input end to signal out end of a same scan line 303.

Specifically, scan line 303 includes convex part 308 at location corresponding to adjacent thin film transistor, drain terminal d1 of thin film transistor includes extension part 309, overlapping part of convex part 308 and extension part 309 forms parasitic capacitor, wherein area of extension part 309 increases from signal input end to signal output end along same scan line 303. The contrast between FIG. 4 and FIG. 5 shows that area of extension part 309 at signal input end of scan line 303 is less than area of extension part 309 at signal output end of scan line 303.

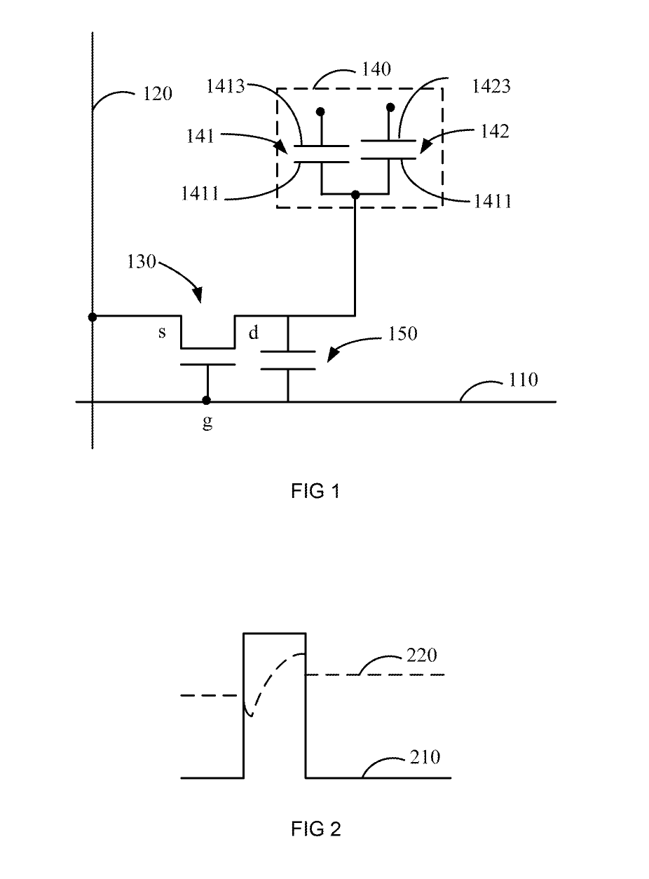

Because drive circuit of the present invention is the same as drive circuit of known technique shown in FIG. 1, refer to FIG. 1. In an absolute ideal condition, capacitance of parasitic capacitor 150 satisfying following equation:

$$Δ V = Δ {V}_{g} * \frac{{C}_{gs}}{{C}_{gs} + {C}_{sl} + {C}_{lc}}$$

In the instant embodiment, ΔV is compensation voltage, ΔV_{g} is difference between high voltage and low voltage of scan signal inputted to gate terminal g of thin film transistor of a pixel unit 140, Cₛₜ is capacitance of storage capacitor 142 of pixel unit 140, and C_{lc} is capacitance of liquid crystal capacitor 141 of pixel unit 140. C_{gs} is capacitance of parasitic capacitor 150. At this point, feed-through voltage of the same scan line from input end to output end stays the same, and liquid crystal display device has uniform illumination and best effect of displaying.

Obviously, it is also possible to increase area of convex part 308 from signal input end to signal output end along same scan line 303 and keep area of extension part 309 the same to achieve the objective of having parasitic capacitance increasing from signal input end to signal output end along same scan line 303.

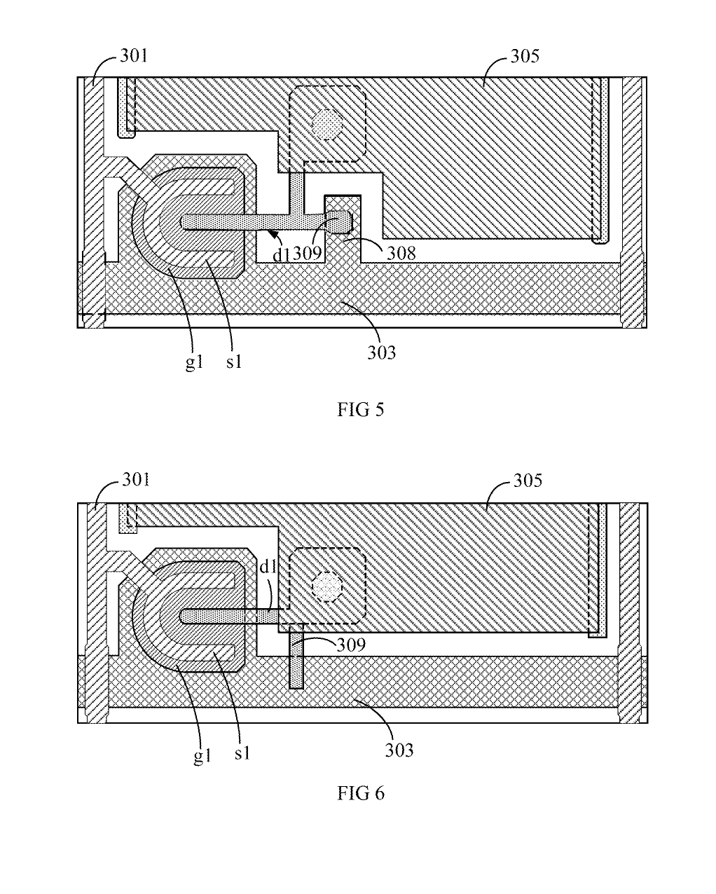

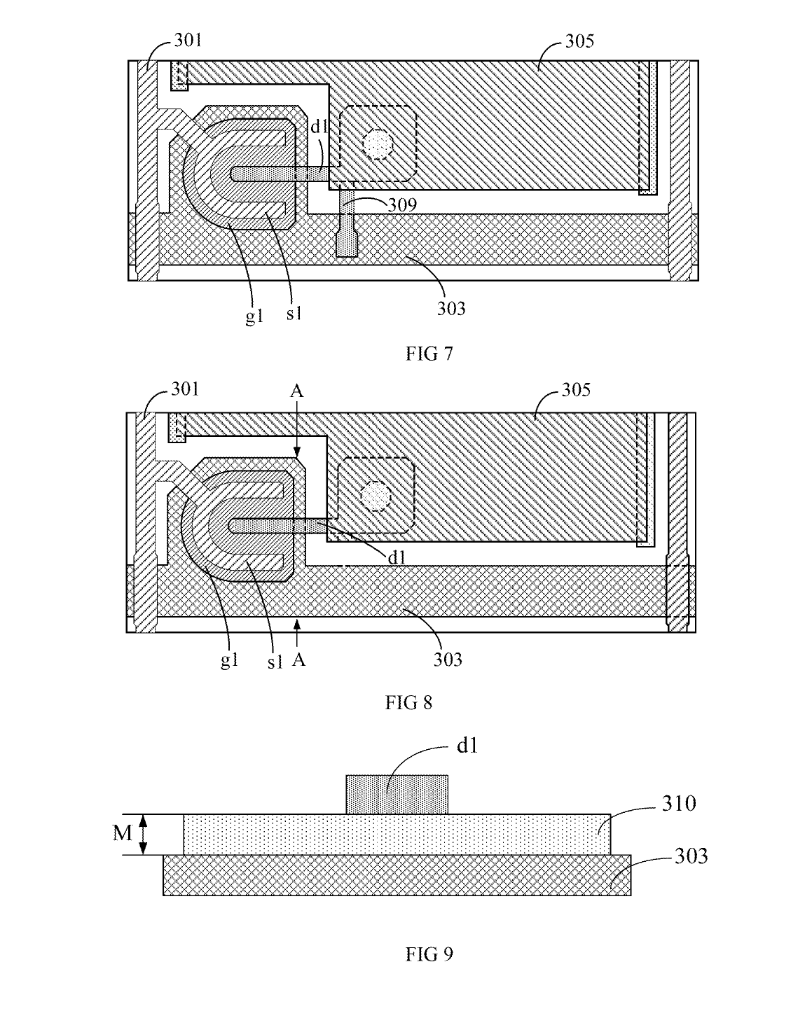

Referring to FIGS. 6-7; FIG. 6 is a schematic view showing the structure of a parasitic capacitor at signal input end of the second embodiment of the liquid crystal display panel according to the present invention; and FIG. 7 is a schematic view showing the structure of a parasitic capacitor at signal output end of the second embodiment of the liquid crystal display panel according to the present invention. The difference between this embodiment and embodiment of FIGS. 4-5 is that extension part 309 of drain terminal d1 of thin film transistor extends to area of scan line 303, and overlaps partially with scan line 303 to form parasitic capacitor, wherein area of extension part increases from signal input end to signal output end of same scan line. The contrast between FIG. 6 and FIG. 7 shows that area of extension part on scan line at location close to signal input end is less than area of extension part on scan line at location close to signal output end.

Referring to FIGS. 8-9, FIG. 8 is a schematic view showing the structure of the third embodiment of the liquid crystal display panel according to the present invention; and FIG. 9 is a cross-section view along A-A direction of FIG. 8. In the instant embodiment, drain terminal d1 of thin film transistor, insulation layer 310 and scan line 303 overlap partially to form parasitic capacitor, and overlapping distance M of drain terminal d1 of thin film transistor and scan line 303 decreases from signal input end to signal output end of same scan line 303.

It should be noted that other dielectric material can be sandwiched between drain terminal d1 of thin film transistor and scan line 303 to form parasitic capacitors, and will not be listed here.

It is also easy to deduce that different dielectric material can be added in overlapping part of drain terminal d1 of thin film transistor and scan line 303 so that capacitance of parasitic capacitor of overlapping part between drain terminal d1 of thin film transistor and scan line 303 increases from signal input end to signal output end of same scan line 303.

The present invention also provides a liquid crystal display device, which comprises a liquid crystal display panel of any of above embodiments.

To distinguished from the known techniques, the present invention uses parasitic capacitors formed by overlapping drain terminal of thin film transistor and scan line, and capacitance increases from signal input end to signal output end along scan line, so that feed-through voltage at output end approaches the same as feed-through voltage at input end to effectively reduce impact on pixels from signal input end to signal output end along same scan line by feed-through voltage, and improve the illumination uniformity of liquid crystal display device, and improve quality of displaying.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A liquid crystal display panel, which comprises: data lines, scan lines disposed intersecting the data lines, pixel electrodes within area formed by two adjacent scan lines and two adjacent data lines, and thin film transistors disposed at intersecting points of scan lines and data lines; gate terminal of thin film transistor connected to scan line, source terminal of thin film transistor connected to data line and drain terminal of thin film transistor connected to pixel electrode;
wherein overlapping area of drain terminal of thin film transistor and scan line forming parasitic capacitor C_{gs}, and the overlapping area of drain terminal of thin film transistor and scan line increasing from signal input end to signal out end of a same scan line so that capacitance of parasitic capacitor C_{gs} increasing along the same line; wherein capacitance of parasitic capacitor C_{gs} satisfying following equation:
$$Δ V = Δ {V}_{g} * \frac{{C}_{gs}}{{C}_{gs} + {C}_{sl} + {C}_{lc}}$$
wherein ΔV is compensation voltage, ΔV_{g} is difference between high voltage and low voltage of scan signal inputted to gate terminal of thin film transistor of a pixel unit, Cₛₜ is capacitance of storage capacitor of pixel unit, and C_{lc} is capacitance of liquid crystal capacitor of pixel unit.

2. The panel as claimed in claim 1, characterized in that the scan line comprises convex part at location corresponding to adjacent thin film transistor, the drain terminal of thin film transistor comprises extension part, overlapping part of the convex part and extension part forms parasitic capacitor C_{gs}, wherein area of convex part on scan line at location close to signal input end is less than area of convex part on scan line at location close to signal output end.

3. The panel as claimed in claim 2, characterized in that area of convex part increases from signal input end to signal output end of same scan line, and area of extension part remains the same.

4. A liquid crystal display panel, which comprises: data lines, scan lines disposed intersecting the data lines, pixel electrodes within area formed by two adjacent scan lines and two adjacent data lines, and thin film transistors disposed at intersecting points of scan lines and data lines; gate terminal of thin film transistor connected to scan line, source terminal of thin film transistor connected to data line and drain terminal of thin film transistor connected to pixel electrode;
wherein overlapping area of drain terminal of thin film transistor and scan line forming parasitic capacitor C_{gs}, and the overlapping area of drain terminal of thin film transistor and scan line increasing from signal input end to signal out end of a same scan line so that capacitance of parasitic capacitor C_{gs} increasing along the same line.

5. The panel as claimed in claim 4, characterized in that capacitance of parasitic capacitor C_{gs} satisfying following equation:
$$Δ V = Δ {V}_{g} * \frac{{C}_{gs}}{{C}_{gs} + {C}_{sl} + {C}_{lc}}$$
wherein ΔV is compensation voltage, ΔV_{g} is difference between high voltage and low voltage of scan signal inputted to gate terminal of thin film transistor of a pixel unit, Cₛₜ is capacitance of storage capacitor of pixel unit, and C_{lc} is capacitance of liquid crystal capacitor of pixel unit.

6. The panel as claimed in claim 4, characterized in that area of overlapping part between drain terminal of thin film transistor and scan line increases from signal input end to signal output end of same scan line.

7. The panel as claimed in claim 6, characterized in that the scan line comprises convex part at location corresponding to adjacent thin film transistor, the drain terminal of thin film transistor comprises extension part, overlapping part of the convex part and extension part forms parasitic capacitor C_{gs}, wherein area of convex part on scan line at location close to signal input end is less than area of convex part on scan line at location close to signal output end.

8. The panel as claimed in claim 7, characterized in that area of convex part increases from signal input end to signal output end of same scan line, and area of extension part remains the same.

9. The panel as claimed in claim 6, characterized in that scan line comprises convex part at location corresponding to adjacent thin film transistor, the drain terminal of thin film transistor comprises extension part, overlapping part of the convex part and extension part forms parasitic capacitor C_{gs}, wherein area of extension part on scan line at location close to signal input end is less than area of extension part on scan line at location close to signal output end.

10. The panel as claimed in claim 9, characterized in that area of extension part increases from signal input end to signal output end of same scan line, and area of convex part remains the same.

11. The panel as claimed in claim 6, characterized in that the drain terminal of thin film transistor comprises extension part, overlapping part of the scan line and extension part forms parasitic capacitor C_{gs}, wherein area of extension part increases from signal input end to signal output end of same scan line.

12. The panel as claimed in claim 4, characterized in that distance of overlapping part between drain terminal of thin film transistor and scan line decreases from signal input end to signal output end of same scan line.

13. A liquid crystal display device, which comprises: a liquid crystal panel and a backlight module, wherein:
the liquid crystal panel comprises: data lines, scan lines disposed intersecting the data lines, pixel electrodes within area formed by two adjacent scan lines and two adjacent data lines, and thin film transistors disposed at intersecting points of scan lines and data lines; gate terminal of thin film transistor connected to scan line, source terminal of thin film transistor connected to data line and drain terminal of thin film transistor connected to pixel electrode;
wherein overlapping area of drain terminal of thin film transistor and scan line forming parasitic capacitor C_{gs}, and the overlapping area of drain terminal of thin film transistor and scan line increasing from signal input end to signal out end of a same scan line so that capacitance of parasitic capacitor C_{gs} increasing along the same line.

14. The device as claimed in claim 13, characterized in that capacitance of parasitic capacitor C_{gs} satisfying following equation:
$$Δ V = Δ {V}_{g} * \frac{{C}_{gs}}{{C}_{gs} + {C}_{sl} + {C}_{lc}}$$
wherein ΔV is compensation voltage, ΔV_{g} is difference between high voltage and low voltage of scan signal inputted to gate terminal of thin film transistor of a pixel unit, Cₛₜ is capacitance of storage capacitor of pixel unit, and C_{lc} is capacitance of liquid crystal capacitor of pixel unit.

15. The device as claimed in claim 13, characterized in that area of overlapping part between drain terminal of thin film transistor and scan line increases from signal input end to signal output end of same scan line.

16. The device as claimed in claim 15, characterized in that scan line comprises convex part at location corresponding to adjacent thin film transistor, the drain terminal of thin film transistor comprises extension part, overlapping part of the convex part and extension part forms parasitic capacitor C_{gs}, wherein area of convex part on scan line at location close to signal input end is less than area of convex part on scan line at location close to signal output end.

17. The device as claimed in claim 16, characterized in that area of convex part increases from signal input end to signal output end of same scan line, and area of extension part remains the same.

18. The device as claimed in claim 15, characterized in that scan line comprises convex part at location corresponding to adjacent thin film transistor, the drain terminal of thin film transistor comprises extension part, overlapping part of the convex part and extension part forms parasitic capacitor C_{gs}, wherein area of extension part on scan line at location close to signal input end is less than area of extension part on scan line at location close to signal output end.

19. The device as claimed in claim 18, characterized in that area of extension part increases from signal input end to signal output end of same scan line, and area of convex part remains the same.

20. The device as claimed in claim 15, characterized in that the drain terminal of thin film transistor comprises extension part, overlapping part of the scan line and extension part forms parasitic capacitor C_{gs}, wherein area of extension part increases from signal input end to signal output end of same scan line.
